(19) United States
(12) Patent Application Publication
(10) Pub. No.: US 2005/0125829 A1
(43) Pub. Date: Jun. 9, 2005

(54) Apparatus for switching external input

(75) Inventor: Koichi Ozaki, Takefu-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/000,367

(22) Filed: Dec. 1, 2004

(30) Foreign Application Priority Data
Dec. 4, 2003 (JP) 2003-405626

(51) Int. Cl. H04N 7/18; G09B 5/00

(52) U.S. Cl. 725/74; 434/118

(57) ABSTRACT

To prevent the power of a television set from being turned on automatically by an unintended turn-on of the power of external device when the power of the television set is off. When turn-on of the power of the external device is detected, time count starts. When the second turn-on of the power of the external device is detected in a predetermined time after the detection of turn-off of the power of the external device, the power is turned on and the video is displayed. When the power of the external device is not turned off, when the second turn-on of the power is not detected, or when the second turn-on of the power occurs over the predetermined time, the power of the television set is not turned on.

### BACKGROUND OF THE INVENTION

1. Technical Field

The present invention relates to an audiovisual apparatus such as a television set for outputting video and sound input from an external device such as a recording/reproducing device.

2. Description of the Related Art

An audiovisual apparatus such as a television set has a plurality of input terminals for connecting an external device such as a recording/reproducing device. When a video signal is output from an external device connected to an input terminal, the audiovisual apparatus displays a video on a screen and emits a sound from a speaker.

Even if the power is off, when the input terminal receives an input signal from the external device, the audiovisual apparatus turns on the power automatically and starts the operation of displaying the video. Such audiovisual apparatus having the automatic power-on function is disclosed in Japanese Patent Application Laid-Open No. 9-135406. That is, the audiovisual apparatus determines whether or not a video signal is input to the input terminal. When the video signal is input, the audiovisual apparatus turns on the power and displays the input video.

Providing that the audiovisual apparatus has the above-mentioned automatic power-on function, when the power of the external device is turned on, the video signal is input and the power of the audiovisual apparatus is turned on automatically and the video is displayed. However, even when the power of the external device is turned off automatically, the power of the audiovisual apparatus remains on unless the user turns it off.

For example, a recording/reproducing device that receives television broadcasting has a just clock function of adjusting a time lag of a built-in clock by utilizing the time signal of television broadcasting. The power of the recording/reproducing device is turned on automatically immediately before the signal goes out and then turned off automatically. At this time, the recording/reproducing device outputs a video signal of the received channel to an input terminal of the audiovisual apparatus. The audiovisual apparatus detects the video signal and turns on the power automatically to display the video. Alternatively, when the recording/reproducing device performs timer-recording, the video signal is input to the audiovisual apparatus and the power is turned on automatically.

However, irrespective of the user's intention, for example, in the nighttime or when the user is away from home, there may be cases where the power of the audiovisual apparatus is turned on and the state remains. At this time, even when the video signal is not input from the external device, the audiovisual apparatus continues to operate with no image being displayed on the screen. In this state, electric power is consumed wastefully and the user may be worried about failure.

### SUMMARY OF THE INVENTION

In light of the above-mentioned situation, the present invention intends to provide an audiovisual apparatus that prevents the power from being turned on automatically even when a signal is input from an external device irrespective of the user's intention.

The present invention provides an audiovisual apparatus which comprises a plurality of input terminals for connecting external devices, an output device that operates based on an input signal from the external devices, and a control device that controls driving of the output device, wherein the control device has an input detecting means for detecting the presence of an input from the input terminal and a driving means for starting operation of the output device when the input has a unique mode different from a normal mode. The output device refers to devices that outputs video and sound including, for example, a display device such as CRT, liquid crystal display, and plasma display, and a speaker and the like.

When an input signal is received from the external device in the normal input mode, the control device with an automatic power-on function determines that this input is an unintended input from the external device. At this time, the operation of the output device is not started. In the meantime, it is assumed that an input signal in the unique input mode is not generated unless the user performs intentionally. Namely, when the user desires to have the audiovisual apparatus operate interlocking with the external device, an input signal in the unique mode is output from the external device. When detecting the input signal in the unique mode, the control device actuates the output device. Thus, the output device is to be prevented from operating irrespective of the user's intention.

The control device comprises a first operation mode for starting operation of the output device when an input in the normal mode is received and a second operation mode for starting operation of the output device when an input in the unique mode is received. Either mode of the two is set for each input terminal. Consequently the operation mode is to be set according to the type of the external devices. Thus, the output device is to be prohibited from operating irrespective of the user's intention while allowing the automatic power-on function to be effective.

The external device that actuates the output device irrespective of the user's intention outputs a signal in a predetermined time. The second operation mode is set for the input terminal connected with such external device.

The control device sets priorities to the plurality of the input terminals for determining which input is to be accepted from among the plurality of input terminals when input signals are received simultaneously from the plurality of the external devices. By determining the priorities, the operation of the audiovisual apparatus is to be prevented from switching by the input from the other external devices while operating.

Herein, the presence of the input may be detected by detecting turn-on/off of the power of the external device. The control device that controls turn-on/off of the power of the apparatus interlocking with the external devices is provided with an input detecting means for detecting turn-on/off of the power of the external devices when the power of the apparatus is off, and a driving means for turning on the power of the apparatus when it is detected that turn-on/off of the power of the external devices is repeated. By turning the power on, the power is supplied to the output device to start operating.

The input detecting means detects turn-on/off of the power of the external devices in a predetermined time. When detecting that the power is turned on only once in the predetermined time, the control device determines it is of a normal input mode. Accordingly, the driving means holds the power off and the output device does not operate. When detecting that the power is turned on plural times in the predetermined time, the control device determines that it is of a unique input mode. The driving means turns on the power and the output device starts operating.

### EFFECTS OF THE INVENTION

According to the present invention, when an input is received in a unique input mode other than a normal mode from an external device, it allows the apparatus to start operating such as turn-on of the power. Consequently, even when an input is received from an external device irrespective of the user's intention, if it is of a normal input mode, the apparatus is to be prevented from automatically turning the power on. Accordingly, it can be avoided that the audiovisual apparatus operates for nothing in the nighttime or when the user is away from home.

### BRIEF DESCRIPTION OF DRAWINGS

FIG. 1 is a block diagram showing a schematic configuration of a television set of the present invention;

FIG. 2 is a view showing a setting screen for automatic switch; and

FIG. 3 is a flowchart at the operation of automatic power-on.

### DESCRIPTION OF THE PREFERRED EMBODIMENT

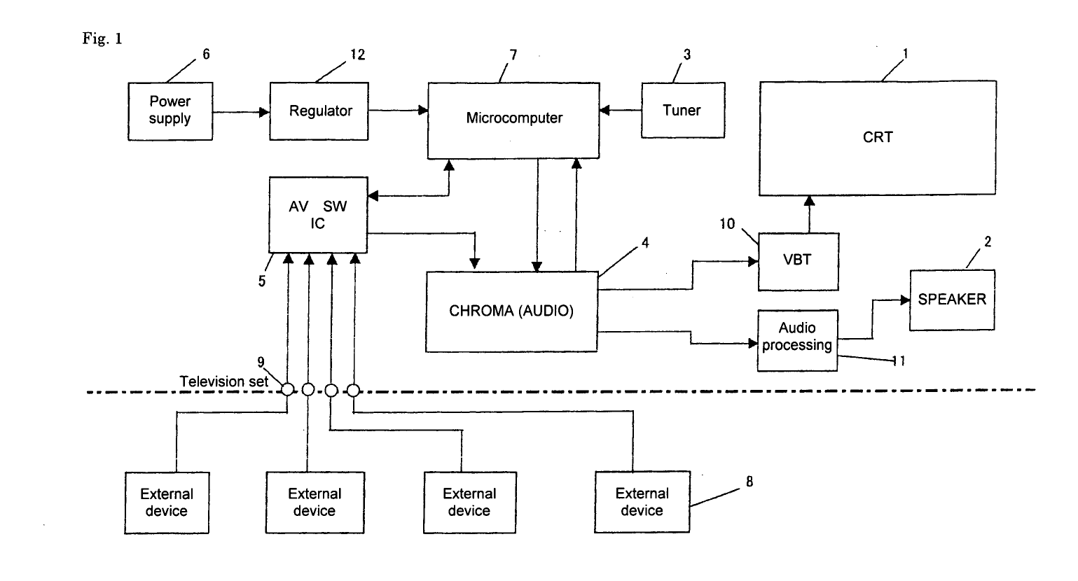

FIG. 1 shows a television set as an audiovisual apparatus of an embodiment in the present invention. The television set has a display device 1, a speaker 2, a tuner 3, an audiovisual processing circuit 4, an input switching circuit 5, a power supply device 6, a control device 7 and a plurality of input terminals 9 for connecting external devices 8.

The input terminals 9 are connected to a digital recording/reproducing device or an analog recording/reproducing device which performs recording and reproducing of recording medium such as DVD, CD, hard disk and video tape, and further a digital video camera, a digital camera, and a personal computer and the like as the external devices 8, and receive input of a video signal of moving picture or still picture. The video signal herein includes an audio signal.

The input switching circuit 5 having a switch IC selects an input signal from each input terminal 9 and outputs the selected signal to the audiovisual processing circuit 4. The audiovisual processing circuit 4 having a chroma IC processes the input video signal so as to be displayed as a video and separates an audio signal therefrom. The signal-processed video signal is output to the display device 1 including a CRT and said display device 1 charged with a high-voltage supplied from a fly-back transformer (FBT) 10 displays the video. An audio processing circuit 11 amplifies the audio signal output from the audiovisual processing circuit 4 and makes the speaker 2 sound.

The power supply device 6 transforms a commercial power and supplies it to each device and each circuit, and supplies a DC power to the control device 7 through a regulator 12. The control device 7 is composed of a microcomputer having CPU, ROM and RAM and controls the whole of the apparatus according to a built-in program so as to output the input video signal from the display device 1 and speaker 2.

The television set of the present invention has an automatic power-on function. Accordingly, the control device 7 has an input detecting means for detecting turn-on/off of the power of the external device 8 when the power of the apparatus is off and a driving means for turning on the power of the apparatus when the power of the external device 8 is on. Further, the driving means has a function of turning on the power of the apparatus when turn-on/off of the power of the external device 8 is repeated. In a predetermined time, if just one turn-on operation of the power of the external device 8 is detected, that means a normal input mode and the operation of turning on the power of the apparatus in the normal input mode is defined as a first operation mode. In the meantime, if turn-on/off operations of the power of the external device 8 are detected repeatedly, that means a unique input mode other than the normal mode and the operation of turning on the power of the apparatus in the unique input mode is defined as a second operation mode.

The input detecting means detects turn-on/off of the power based on the presence of the input signal input to each input terminal 9. That is, when the power of the external device 8 is turned on, the external device 8 outputs a signal such as video signal to the television set. This input signal is input to the control device 7 through the input terminal 9. Accordingly, by detecting the presence of the input signal input from the external device 8, it is determined whether the power of the external device 8 is on or off. In the case of the presence of the input signal, it is assumed that the power of the external device 8 is on. In the case of absence of the input signal, it is assumed that the power of the external device 8 is off.

For instance, when the video signal is input, the input detecting means detects a synchronizing signal of the video signal, for example, either or both of a horizontal synchronizing signal and a vertical synchronizing signal and determines turn-on/off of the power.

The input detecting means detects turn-on/off of the power for a predetermined time. In other words, the input detecting means detects the number of times of turned-on of the power starting from the time when the initial turn-on of the power is detected until the end of the predetermined time. Thus it is determined whether the power is turned on only once or turned on and off several times repeatedly.

The driving means controls the power supply device 6 in each operation mode and supplies the power to each device and each circuit to make each device and each circuit start operating. Namely, turning-on the power makes each device and each circuit start operating, so that the operation based on the input signal is executed. For example, when the video signal is input from the external device 8, the input switching circuit 5 outputs the video signal to the audiovisual processing circuit 4 and the video is displayed. Since the power is supplied to the control device 7 at all times, the presence of the input signal from the input terminal 9 can be detected even when the power is not on.

The control device 7 sets arbitrarily which operation mode is to be applied for each input terminal 9. Alternatively, the control device 7 can set so that each input terminal 9 does not perform both operation modes. In this case, the user needs to turn on the power manually.

Next, an automatic power-on operation will be described. The television set has four input terminals 9. It is assumed that a digital recording/reproducing device such as DVD and hard disk is connected to a first input terminal 9, an analog recording/reproducing device such as videotape is connected to a second input terminal 9, a digital video camera is connected to a third input terminal 9 and nothing is connected to a fourth input terminal 9. The analog recording/reproducing device has a just-clock function and turns on the power at a predetermined time and then turns off the power automatically.

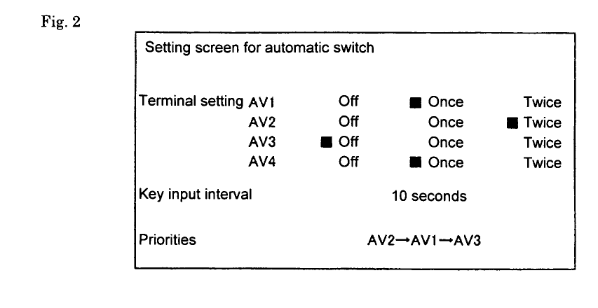

Firstly, a presence or an absence of automatic switch for the input terminals 9 is set. By the operation of an operating device such as remote controller, as shown in FIG. 2, a setting screen for automatic switch is displayed on a display device 1 by the control device 7. An operation mode is set by selecting either “once” or “twice” for each input terminal 9. “Once” and “twice” means a first operation mode and a second operation mode, respectively. The first operation mode is set for the first input terminal 9, the second operation mode is set for the second input terminal 9 and the first operation mode is set for the fourth input terminal 9. No operation mode is set for the third input terminal 9. “Off” is provided for setting whether or not the input switching circuit 5 is to operate automatically when an input signal is received. By selecting “off”, the control device 7 is set not to turn on the power even though an input signal is received, so that the input switching circuit 5 is kept away from operating. Consequently, the user needs to turn on the power manually to perform input switching in order to input and display a video signal from the external device 8 connected to the third input terminal 9.

A key input interval as a predetermined time for detecting turn-on/off the power is set. Here, the interval is set as 10 seconds. It is better to set the predetermined time shorter than the time during which the recording/reproducing device operates according to the just-clock function (generally, about 6 minutes).

Further, priorities are set for each input terminal 9 in order to decide the preference among input signals from plural external devices 8, when the power of the plural external devices 8 is turned on. In this case, the first priority is set to the second input terminal, the second priority to the first input terminal and the third priority to the third input terminal.

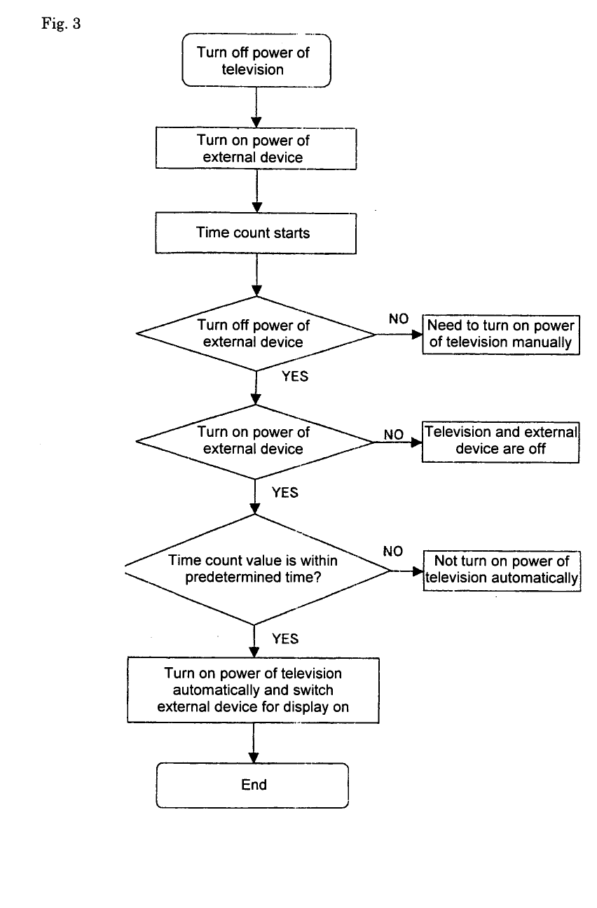

As shown in FIG. 3, the power of the television set is off. While the power is off, the control device 7 still detects turn-on/off of the power of the external device 8. However, the automatic power-on function does not work, as a matter of fact, if the power of the television set has been already turned on.

When the power of the external device 8 connected to the second input terminal 9 is turned on, the signal is input from the external device 8 to the second input terminal 9. The control device 7 detects the presence of the input signal to each input terminal 9 at all times, and when the control device 7 detects that the input signal is input from the second input terminal 9, time count starts. The control device 7 further continues to detect turn-on/off of the power of the external device 8.

If a predetermined time passes without turning-off the power of the external device 8, the control device 7 does not perform the second operation mode. Accordingly, the power of the television set is not turned on automatically. The user needs to turn on the power manually. For example, there is a case where the power of the external device 8 is turned on according to the just-clock function or timer recording. Consequently, the television set is thus prevented from unnecessary operation of turning the power on.

When the power of the external device 8 is turned off, the input signal to the second input terminal 9 disappears and the control device 7 detects that the power is turned off. Subsequently, if the power of the external device 8 is not turned on again, the control device 7 does not perform the second operation mode, so that the turn-off state is maintained.

When the power of the external device 8 is turned on again, the input signal is input to the second input terminal 9 and the control device 7 detects the second turn-on of the power. At this time, according to the value of timecount, it is determined whether the second turn-on of the power is performed in a predetermined time. If the second turn-on of the power is performed in a predetermined time, the second operation mode is performed. That is, the control device 7 turns on the power and supplies the power to each device and each circuit. By the control device 7, the input switching circuit 5 is switched so as to output the input signal from the second input terminal 9. The input signal which is a video signal from the external device 8, is output from the input switching circuit 5 to the audiovisual processing circuit 4. Subsequently, the video is displayed on the display device 1 and the sound is emitted from the speaker 2.

When timing of the second turn-on of the power exceeds the predetermined time, the control device 7 does not perform the second operation mode and the turn-off state is maintained. Since the input switching circuit 5 does not operate, the input signal from the external device 8 is blocked by the input switching circuit 5. At this time, when the user turns on the power and performs input switching manually, the video from the external device 8 is displayed on the display device 1.

When the input signal of the external device 8 is detected in the state where the power of the television set is off, and the power is turned on automatically, then the power of the external device 8 is turned off. The television set remains power on. In this situation, if the operation such as channel switching is not performed for a certain time, when the control device 7 detects that no signal including the input signal from the external device exists for a certain time, the control device 7 turns off the power automatically. At this time, the control device 7 turns off the power arranging a condition for the input signal from a tuner 3 to output. Namely, the control device 7 automatically sets channel, sound volume, brightness and the like in the state prior to turn-on of the power, and then turn-off the power. As a result, when the power of the television set is turned on in the next opportunity, the video on the channel previously viewed and listened is displayed.

The above-mentioned turn-on/off of the power of the external device 8 is performed by the intentional operation of the user. This may be performed automatically by the external device 8. For example, the external device 8 is provided with a dedicated interlocking switch. By operating the interlocking switch, turn-on/off of the power is performed automatically in a predetermined time. In this case, turn-on/off of the power may be repeated twice or more.

When the power of the external device 8 connected to the first input terminal 9 in place of the external device 8 connected to the second input terminal 9 is turned on, the control device 7 detects the turn-on of the power and performs the first operation mode. That is, the power of the television set is turned on and the video from the external device 8 is displayed on the display device 1.

When the power of the external device 8 connected to the first input terminal 9 and that of the external device 8 connected to the second input terminal 9 are turned on simultaneously, the control device 7 detects turn-on of each power. Subsequently, priorities for each input terminal 9 are checked and the input switching circuit 5 is switched so as to select the input signal from the input terminal 9 of high priority. As a high priority is given to the second input terminal 9 in this case, the control device 7 performs the second operation mode and detects the presence of the second turn-on of the power.

There may be a case where the control device 7 detects the input signal from the second input terminal 9 and then the power of the external device 8 connected to the other input terminal 9 is turned on in a predetermined time. In this case, the control device 7 gives a higher priority to perform the second operation mode and does not turn on the power even if the input signal from the external device 8 is detected.

The present invention is not limited to the above-mentioned embodiment and as a matter of course, a lot of modifications and alterations can be made to the above-mentioned embodiment within the scope of the present invention. The audiovisual apparatus is not limited to the television set, but may be a monitor, recording/reproducing device or personal computer.

Further, when turn-on/off of the power of the external device is detected, the external device may be intentionally configured so as to generate and output a unique signal different from a normal signal rather than detecting the presence of the video signal from the input terminal. For example, as for the video signal with the audio signal output from the external device, the video signal containing no audio signal or only the audio signal may be output. Further, when the audio signal is a stereo signal, either right or left audio signal may be output. Or output timing of the signal may be changed as well.

1. An audiovisual apparatus comprising:
a plurality of input terminals for connecting external devices;
an output device that operates based on an input signal from the external devices; and
a control device that controls driving of the output device, wherein
the control device has an input detecting means for detecting the presence of an input from the input terminal and a driving means for starting operation of the output device when the input has a unique mode different from a normal mode.

2. The audiovisual apparatus as stated in claim 1, wherein the control device sets priorities to the plurality of input terminals for determining which input is to be accepted from among the plurality of input terminals when input signals are received simultaneously from the plurality of the external devices.

3. The audiovisual apparatus as stated in claim 1, wherein the control device comprises a first operation mode for starting operation of the output device when an input in the normal mode is received and a second operation mode for starting operation of the output device when an input in the unique mode is received, and either of the two modes is set for each input terminal.

4. The audiovisual apparatus as stated in claim 3, wherein the second operation mode is set for the input terminal connected with the external device that outputs a signal in a predetermined time.

5. An audiovisual apparatus comprising:
a plurality of input terminals for connecting external devices; and
a control device that controls turn-on/off of the power of the apparatus interlocking with the external devices, wherein
the control device is provided with an input detecting means for detecting turn-on/off of the power of the external devices when the power of the apparatus is off, and a driving means for turning on the power of the apparatus when it is detected that turn-on/off of the power of the external devices is repeated.

6. The audiovisual apparatus as stated in claim 5, wherein the input detecting means detects turn-on/off of the power of the external devices in a predetermined time, and when detecting that the power is turned on only once in the predetermined time, the driving means holds the power off.

7. The audiovisual apparatus as stated in claim 5, wherein the control device sets priorities to the plurality of the input terminals for determining which external device is to be preferred when the powers of the plurality of the external devices are turned on.

8. The audiovisual apparatus as stated in claim 2, wherein the control device comprises a first operation mode for starting operation of the output device when an input in the normal mode is received and a second operation mode for starting operation of the output device when an input in the unique mode is received, and either of the two modes is set for each input terminal.

9. The audiovisual apparatus as stated in claim 8, wherein the second operation mode is set for the input terminal connected with the external device that outputs a signal in a predetermined time.

10. The audiovisual apparatus as stated in claim 6, wherein the control device sets priorities to the plurality of the input terminals for determining which external device is to be preferred when the powers of the plurality of the external devices are turned on.
